(19) United States
(12) Patent Application Publication
(10) Pub. No.: US 2010/0269426 A1
(43) Pub. Date: Oct. 28, 2010

(54) GLAZED SKYLIGHT ASSEMBLY

(75) Inventors: Stephen Richter, Arlington, WA (US); Donald Trombley, Marysville, WA (US)

Correspondence Address: GRAYBEAL JACKSON LLP, 400 - 108TH AVENUE NE, SUITE 700, BELLEVUE, WA, 98004, US

(73) Assignee: Crystalite Inc., Everett, WA (US)

(21) Appl. No.: 12/760,307

(22) Filed: Apr. 14, 2010

Related U.S. Application Data
(60) Provisional application No. 61/171,736, filed on Apr. 22, 2009.

(51) Int. Cl. E04D 13/03; E06B 1/04; E06B 3/24; E06B 7/12

(52) U.S. Cl. 52/171.3; 52/204.1; 52/204.593; 52/200; 52/745.15

(57) ABSTRACT

An enhancement panel for a skylight or window that may be part of an assembly having one or more glazing panels suitable for being retrofitted to existing skylights, windows and doors. A panel, also referred to as a glazing, may typically be a transparent part of a door, window, or skylight usually made of a transparent or translucent material, e.g., glass, plastic, acrylic, polycarbonate structured sheet, etc. Alternatively, a pre-assembled skylight, window or door, may include an exterior panel and an enhancement panel in a pre-existing manufactured package to be installed as a single new package. The enhancement panel may create a thermal cavity between the exterior panel and the enhancement panel. Such a thermal barrier may greatly improve the thermal properties of the overall door, window or skylight.

### PRIORITY CLAIM

The present application claims the benefit of copending U.S. Provisional Patent Application Ser. No. 61/171,736, filed Apr. 22, 2009, which application is incorporated herein by reference in its entirety.

### BACKGROUND

Windows, doors and skylights as used in residential and commercial buildings are subject to energy and safety regulations as mandated by national and local construction codes. Such codes require that these products be rated for their structural and thermal characteristics and are often certified by a third party inspection agency. Such structural code requirements may typically be for loading due to snow accumulation or wind conditions as well as other structural concerns such as air infiltration. Thermal code requirements may be for characteristics such as U-factor (heat loss), Solar Heat Gain (SHGC), Condensation Resistance (CR), and Visible Light Transmittance (VT).

The International Energy Conservation Code (IECC) provides a set of standards that are typically adopted by the various states and municipalities when such government entities do not have an equal or more restrictive set of standards. As a result, IECC typically dictates energy efficiency standards and requirements for residential and commercial buildings. The IECC also sets minimum performance levels for associated products such as windows, skylights, and doors. In addition there are various programs such as “Energy Star” that may establish even more restrictive energy guidelines. Thus, to meet the Energy Star guidelines, the products must be certified by a third party inspection agency and rated by The National Fenestration and Rating Council (NFRC). Certified products are listed by manufacturer in the NFRC database (the Certified Products Directory). Thus, those manufacturers, their associated products, and product performance levels, are subject to those wishing to specify a particular product for energy efficiency. The more energy efficient, the balance of U-factor, SHGC, and VLT, the greater chance a highly efficient product will be specified by architects and energy analysts when making material decisions.

Further, the American Recovery and Reinvestment Act of 2009, establishes tax credits for energy efficient products. This legislation provides consumers who purchase windows, doors and skylights, which meet a maximum U-factor of 0.30 and a maximum SHGC of 0.30, a tax credit or rebate of 30% up to a maximum of $1500.00. As a result, improving the efficiency of windows, doors, and skylights is encouraged by various government programs as wells as by manufacturers and consumers. However, conventional windows, doors and skylights may be difficult to improve (e.g., lower the U-factor) once deployed.

### BRIEF DESCRIPTION OF THE DRAWINGS

The foregoing aspects and many of the attendant advantages of the claims will become more readily appreciated as the same become better understood by reference to the following detailed description, when taken in conjunction with the accompanying drawings, wherein:

FIG. 1 shows a diagram of a conventional skylight apparatus.

FIGS. 2 and 3 show diagrams of an assembly having an enhancement panel according to embodiments of the subject matter disclosed herein.

### DETAILED DESCRIPTION

The following discussion is presented to enable a person skilled in the art to make and use the subject matter disclosed herein. The general principles described herein may be applied to embodiments and applications other than those detailed above without departing from the spirit and scope of the present detailed description. The present disclosure is not intended to be limited to the embodiments shown, but is to be accorded the widest scope consistent with the principles and features disclosed or suggested herein.

By way of overview, the subject matter disclosed herein is related to an enhancement panel that may be part of an assembly having one or more glazing panels suitable for being retrofitted to existing skylights, windows and doors. A panel, also referred to as a glazing, may typically be a transparent part of a door, window, or skylight usually made of a transparent or translucent material, e.g., glass, plastic, acrylic, polycarbonate structured sheet, etc. Alternatively, a pre-assembled skylight, window or door, may include an exterior panel and an enhancement panel in a pre-existing manufactured package to be installed as a single new package. The enhancement panel may create a thermal cavity between the exterior panel and the enhancement panel. Such a thermal barrier may greatly improve the U-factor of the overall door, window or skylight. Further, the enhancement panel may include additional treatments such as applied coatings, tinting, shading, and polarizing. Various embodiments are discussed in the following paragraphs.

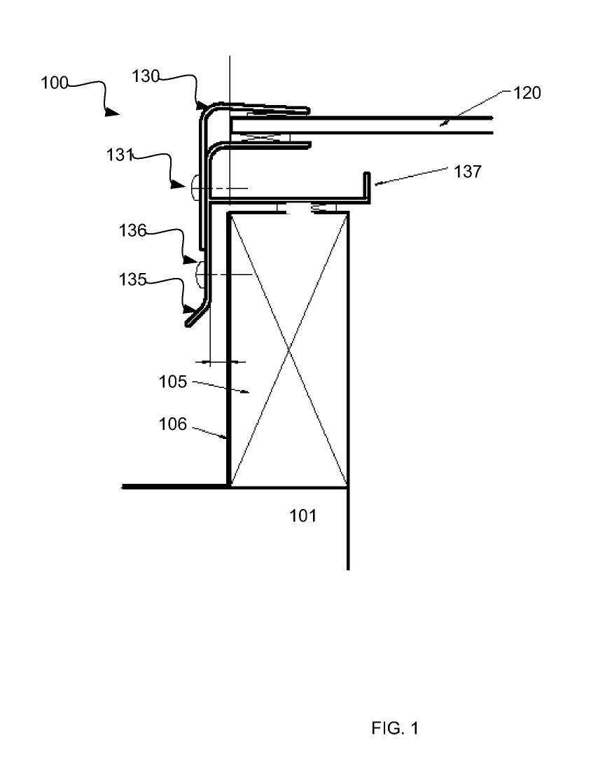

FIG. 1 shows a diagram of a conventional skylight apparatus 100 that does not have any enhancement panel attached. Although shown and discussed throughout the following figures as a skylight, a skilled artisan understands that the same concepts may be applied equally to doors and windows without departing from the spirit and scope of the invention. In FIG. 1, the skylight 100 may be set within a roof 101 such that an opening in the roof is formed for the skylight to be installed wherein the panel 120 covers the opening. The opening may be raised away from a roof line 101 or wall by a curb 105. The curb 105 provides enough rise such that flashing 106 may be attached along the roof line and the curb 105 (of the skylight) for repelling water. Such curb 105 height is typically mandated by structural codes for skylights and may often be four inches matching typical 2×4 building lumber. The curb 105 provides a structure for the skylight itself to be affixed and a seal is formed between the curb and the skylight.

With a suitable opening, the skylight may be installed whereby an exterior skylight frame (consisting of two parts, an interior holding frame member 137 and an exterior holding frame member 130) may be affixed to the opening for holding the exterior panel 120 in place. The interior holding frame member 137 and the exterior holding frame member 130 may be used to capture all sides of the panel 120 and hold it in place. A first retaining member 131 (e.g., a bolt or a screw) may be used to hold the interior holding frame member 137 to the exterior holding frame member 130. Then a second retaining member 136 may be used to hold the entire frame to the curb 105. Further, the interior holding frame member 137 may also include a flange 135 suited to assist with repelling water and precipitation from the curb 105.

This typical skylight assembly (including frame and panel components) is also subject to structural requirements. Thus, the panel 120 is typically tempered and of sufficient thickness to deal with loading and impacts. Further, this panel 120 may have treatments on one or both sides to assist with U-factor ratings and other energy efficiency ratings. Further yet, the panel 120 may comprise, an insulated panel, two or more layers of glass with argon gas or other inert gas between glass layers or any other suitable panel for exterior exposure. Additionally, a substance such as nanogel may be disposed between the layers.

As a result, a single barrier is formed between the interior (e.g., below the panel 120) and the exterior (e.g., above the panel) when the skylight is installed. With such a conventional skylight 100, the temperature change between the inside and the outside may approach an extreme value. For example, a typical indoor temperature may be 70 degrees F. whereas typical outdoor temperature, in colder climates, may approach 0 degrees F. and below. Such an extreme difference in temperature may often lead to condensation on the underside of the panel 120 such that water collects on the inside of a skylight 100 despite having a water-proof seal. Water from condensation is typically collected by a gutter created by a flange 137. Furthermore, with only a single panel 120 separating inside from outside, a greater heat loss exists, i.e., a higher U-factor.

Increasingly stringent building energy codes have caused homebuilders and owners to be more aware of insulating properties of windows, doors, and skylights installed in homes. Specifically, different glazing materials and more layers of glazing materials having specific minimum U-factors are often required to meet code specifications. A particular problem in the glazing industry is satisfying the code specifications without sacrificing light transmission through the glazing layers. In skylight construction, the glazing may often include additional treatments that may be often comprised of light transmitting insulating materials such as, for example, a resin. These light transmitting treatments are frequently employed to attain satisfactory thermal performance. Additional detail about such treated glazings is described in U.S. Pat. No. 5,216,855 Jun. 8, 1993 which is incorporated herein by reference. However, the relative improvement to the overall U-factor of the skylight 100 is limited for many treatments.

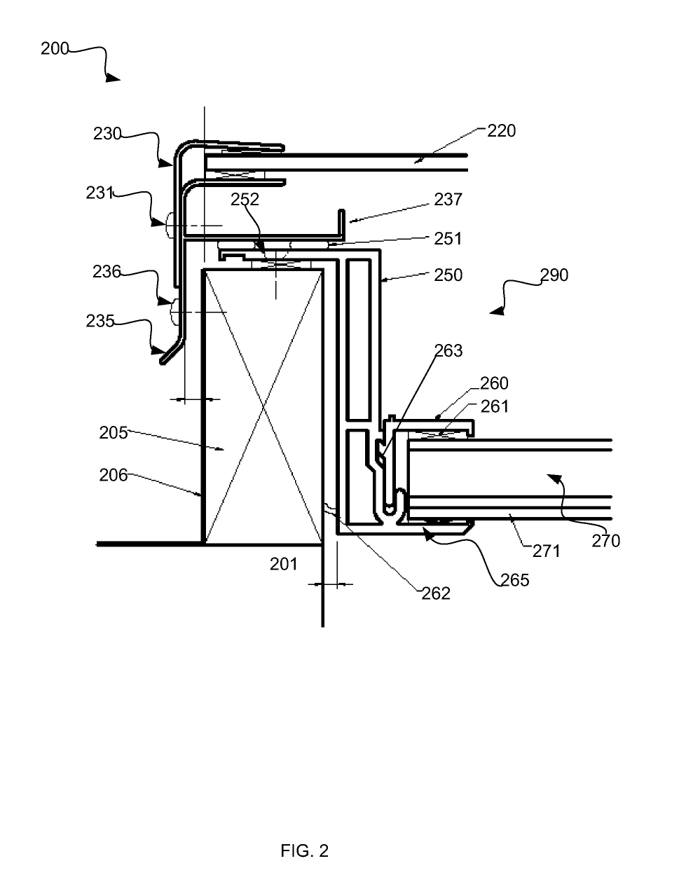

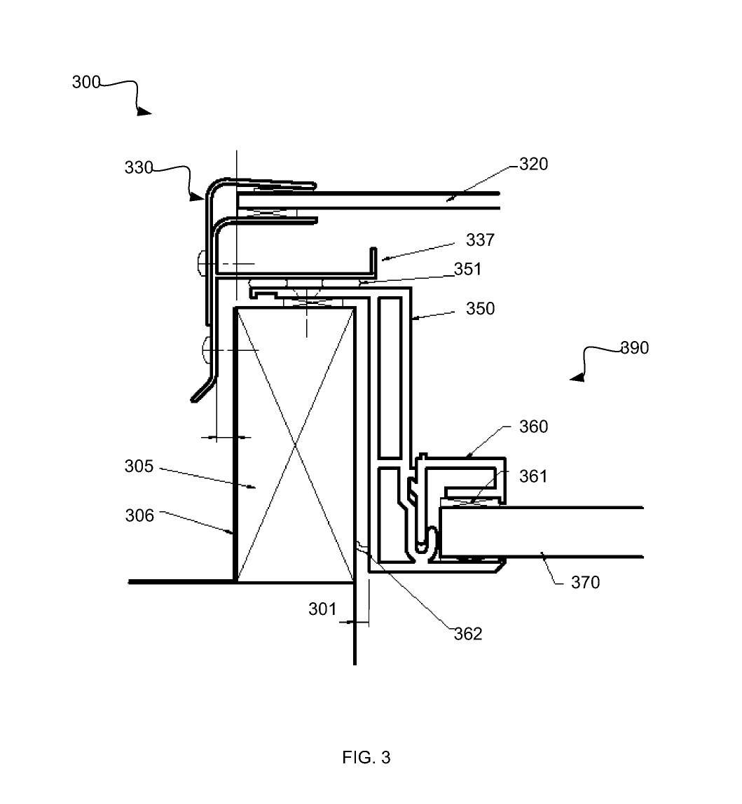

Typical structural codes require that for most skylight installations that the skylight shall be mounted on a curb 105 at least four inches above the roof deck 101. Such a requirement is for roof material flashing 106 and related water intrusion issues. In an installation where the curb 105 is above roof deck 101 (as shown in FIG. 1) makes the skylight 100 less efficient since the “rated skylight product” is accountable for heat losses associated with the curb 105, regardless of who supplied the curb 105 (e.g., a framing contractor). Window manufacturers are not accountable for specifying any heat loss associated with the required framing around a window or door product, and such heat losses are only accounted for in the framing factor of the structure. Thus, the resulting U-Factor for a skylight will be typically higher than a window product of the same glazing. In addition skylights may be tested and rated on a 20-degree slope which may typically add another 15% to 20% to the U-Factor beyond the situation in which the product is tested and rated in a vertical orientation. For example, a skylight simulated and tested vertically may have a U-factor of 0.41. When converted to a 20-degree slope, the U-Factor increases to as much as U=0.49. (Note: a lower number U-factor indicates a higher level of performance). Instead of focusing on additional or different treatments to the panel 120 of FIG. 1, the embodiments discussed below in FIGS. 2 and 3 provide an additional enhancement panel for overcoming inherent problems with the curb-style installation of common skylights.

FIG. 2 shows a diagram of a skylight assembly 200 having a second panel in addition to an exterior panel according to an embodiment of the subject matter disclosed herein. Such an assembly 200 creates a separation (e.g., a cavity 290) between the loading and exterior-rated panel 220 from an interior enhancement panel 270. As such a semi-enclosed cavity 290 may be formed between the top-level exterior panel 220 and the enhancement panel 270. In FIG. 2, the skylight 200 may be set within a roof 201 such that an opening in the roof is formed for the skylight to be installed wherein the panels 220 and 270 cover the opening. The opening may be raised away from a roof line 201 or wall by a curb 205 such that flashing 206 may be attached along the roof line and the curb 205 for repelling water. Such curb 205 height is typically mandated by structural codes for skylights and may often be four inches matching typical 2×4 building lumber.

With a suitable opening, the skylight 200 may be installed whereby an exterior skylight frame (consisting of two parts, an interior holding frame member 237 and an exterior holding frame member 230) may be affixed to the opening for holding the exterior panel 220 in place. The interior holding frame member 237 and the exterior holding frame member 230 may be used to capture all sides of the exterior panel 220 and hold it in place. A first retaining member 231 (e.g., a bolt or a screw) may be used to hold the interior holding frame member 237 to the exterior holding frame member 230. Then a second retaining member 236 may be used to hold the entire frame to the curb 205. Further, the interior holding frame member 237 may also include a flange 235 suited to assist with repelling water and precipitation from the curb 205.

The typical skylight assembly (including frame and panel components) is still subject to structural. Thus, the panel 220 is typically tempered and of sufficient thickness to deal with loading and impacts. Further, the exterior panel 220 may also still have treatments on one or both sides to assist with U-factor ratings and other energy efficiency ratings. Further yet, the exterior panel 220 may still comprise two or more layers of glass with argon gas or other inert gas between glass layers. Additionally, a substance such as nanogel may be disposed between the layers.

The skylight 200 of FIG. 2 also includes an enhancement panel 270 that may be set in an enhancement panel frame assembly 250 operable to hold the enhancement panel at a specified distance below the exterior panel 220. This distance may match the height of the curb 205 (e.g., approximately four inches per the example above) such that the enhancement panel 270 may be flush with an interior wall or ceiling. The enhancement frame 250 may be made from aluminum, vinyl or other suitable material for panel or skylight construction. The resulting full assembly (i.e., the skylight assembly 200) then provides a thermal barrier in the form of a cavity 290 between the exterior panel 220 and the enhancement panel 270.

In this embodiment, such an enhancement panel assembly (the enhancement frame 250 and the enhancement panel 270) may be retrofit to an existing skylight. As such, the enhancement frame 250 includes a top-side engaging flange 252 suited to be set upon the top-side of the curb 206. Then, the interior holding frame member 237 may be set upon the engaging flange. Further, a seal 251 may provide for a water-tight, air-tight seal between the top-side flange 252 and the interior holding member 237. An additional seal 262 at the base of the enhancement frame 250 may also provide for additional separation between an interior and an exterior.

The enhancement frame 250 further includes an enhancement panel holding member 260 that may have a tip 263 for securely engaging the enhancement panel 270. Thus, an enhancement panel 270 may be affixed in place by being secured between a bottom-side engaging flange 265 and the enhancement panel holding member 260. Further, an enhancement panel seal 261 may further provide additional sealing between the interior (e.g., under the enhancement panel and the cavity 290.

Further, snow loading on any skylight or window will deflect the loaded piece of glazing; i.e., detrimentally decrease its thermal efficiency. When such condition occurs, the material at center of exterior glazing is diminished. Since the center of glazing portion of an insulated unit exhibits the best thermal efficiency, it is desirable to not load the insulated unit, particularly in the winter or cooler climates. Because the enhancement panel 270 is held in place below the loaded surface, the enhancement panel is not subjected to any snow load and subsequent deflection thereby maintaining the best desired thermal efficiency.

There are several advantages of the skylight assembly 200 of FIG. 2 over conventional skylights. In a first advantage, having two different panels (220 and 270) allows for the best materials to be used for the most efficient purposes. Thus, the exterior panel 220 may comprise a material suited best for loading and impact requirements but that has less-than-ideal thermal performance ratings. Similarly, the enhancement panel 270 may comprise the most effective energy-efficient glazing at the bottom of the curb 205 as opposed to the near or above the top of the curb. Such an enhancement panel 270 may not need to meet snow loading, wind loading or impact requirements as this panel is not exposed to the exterior. Without such requirements, the enhancement panel 270 may be relatively thin; for example, the enhancement panel may be a structured polycarbonate material that is only ⅝ of an inch thick or less.

Further, in at least a second advantage, the enhancement panel may further include a treatment 271 on any surface of the panel to increase the thermal performance of this panel, such as, for example, applied coatings, tinting, or polarizing. By utilizing the most-efficient treatments 271 at the enhancement panel 270, there is a reduced need to utilize materials compromising the Visible Light Transmittance (VT) (i.e., materials with some kind of treatment) of the exterior panel 220. Often, a manufacturer of a single panel skylight (such as in FIG. 1) will have to compromise the VT of the single panel by providing additional treatments to meet energy efficiency goals. Thus, having a second panel (e.g., the enhancement panel 270), results in the cavity 290 which greatly improves the thermal properties of the skylight without compromising the desired VT characteristic. Additionally, less severe treatments may be applied to the second panel with minimal impact on VT. Therefore, the skylight assembly 200 provides exceptional thermal properties while maintaining a high VT.

In other embodiments where a clear view outside is not important, other glazing materials such as nanogel-filled glazings or structured sheet glazings may be incorporated into the enhancement panel. Nanogel is a material having high-insulating properties that may also suffer from a lower VLT. This option may not be as desirable for residential applications but highly effective for improving heat loss. In still other embodiments, the enhancement panel 270 may include a treatment of a vacuum-interior between two or three glass layers thereby improving the heat-loss efficiency.

In a third advantage of the embodiment of FIG. 2, there is very limited or no associated air infiltration since the enhancement panel 270 isolates and seals off any potential for air infiltration between the cavity 290 and the interior below the enhancement panel 270 (even when the existing skylight may have a high air infiltration rate that may be due to weep holes and the like). As a result, condensation is greatly reduced or eliminated because the enhancement panel 270 does not allow for warm moisture-laden air from the interior to get to the cold surface of the exterior panel 220 because of the thermal barrier created by the cavity 290. This becomes more pronounced in high humidity areas during cold weather, such as in bathrooms, kitchens, and spas. In one embodiment, the enhancement panel 270 improves a single glaze skylight (100 of FIG. 1 with a U-factor of U=1.65) by as much as 1.39 btu/hr/F/sqft. Therefore, adding an enhancement panel 270 may improve the U-factor of the skylight of FIG. 1 by eight times to U=0.26.

In at least a fourth advantage of the skylight of FIG. 2, the assembly 200 as illustrated also provides for better sound transmittance control (STC). The reason for such improvement is because of the cavity 290 between the glazing layers (exterior panel 220 and enhancement panel 270) and the different glazing materials and thicknesses available when two panels are used in the assembly 200. All of these factors improve the STC rating. Such rating may be important near airports and freeways or other locations where sound reduction is mandated by local jurisdictions.

Additional embodiments similar the embodiment described in FIG. 2 are contemplated. One such embodiment is described below with respect to FIG. 3.

FIG. 3 shows a diagram of an assembly 300 according to another embodiment of the subject matter disclosed herein. Such an assembly 300 with a separate exterior panel 320 and enhancement panel 370 also separates the loading and exterior-rated requirements from the energy-efficiency requirements. Again, such an assembly 300 creates a separation (e.g., a cavity 390) between the loading and exterior-rated panel 320 from an interior enhancement panel 370. As such, an enclosed cavity 390 may be formed between the top-level exterior panel 320 and the enhancement panel 370. In FIG. 3, the assembly 300 may be set within a roof 301 such that an opening in the roof is formed for a skylight to be installed wherein the panels 320 and 370 cover the opening. The opening may be raised away from a roof line 301 or wall by a curb 305 such that flashing 306 may be attached along the roof line and the curb 305 for repelling water.

With a suitable opening, the assembly 300 may be installed whereby an exterior skylight frame (consisting of two parts, an interior holding frame member 337 and an exterior holding frame member 330) may be affixed to the opening for holding the exterior panel 320 in place. The interior holding frame member 337 and the exterior holding frame member 330 may be used to capture all sides of the exterior panel 320 hold it in place.

The skylight 300 of FIG. 3 also includes an enhancement panel 370 that may be set in an enhancement panel frame assembly 350 operable to hold the enhancement panel at a specified distance below the exterior panel 320. This distance may match the height of the curb 235 (e.g., four inches per the example above) such that the enhancement panel 370 may be flush with an interior wall or ceiling (e.g., the bottom-side of the curb). The resulting full assembly (i.e., the skylight assembly 300) then provides a thermal barrier in the form of a cavity 390 between the exterior panel 320 and the enhancement panel 370.

In this embodiment, such an enhancement panel assembly (the enhancement frame 350 and the enhancement panel 370) may be retrofit to an existing skylight. As such, the enhancement frame 350 includes a top-side engaging flange 352 suited to be set upon the top-side of the curb 305. Then, the interior holding frame member 337 may be set upon the engaging flange. Further, a seal 351 may provide for a water-tight, air-tight seal between the top-side flange 352 and the interior holding member 337. An additional seal 362 at the base of the enhancement frame 350 may also provide for additional separation between an interior and an exterior.

In this embodiment, the enhancement panel 370 may vary in thickness and material; for example, a single sheet of 16 mm polycarbonate structured sheeting may be used as shown. With a varying-thickness enhancement panel 370, an enhancement panel holding member 360 may be also be varied to hold the enhancement panel in place when engaged. Further, the enhancement panel 370 (as well as the exterior panel 320) may be more than one layer of glazing material. This may typically be the case for planar and domed skylight construction. Both the exterior panel 320 and the enhancement panel 370 may be comprised of two or more layers, each layers comprising one of, for example, glass, acrylic, or polycarbonate layers. The choice of glazing material employed depends upon optimizing such factors as U-Factor, Solar Heat Gain (SHGC), and VT.

While the subject matter discussed herein is susceptible to various modifications and alternative constructions, certain illustrated embodiments thereof are shown in the drawings and have been described above in detail. It should be understood, however, that there is no intention to limit the claims to the specific forms disclosed, but on the contrary, the intention is to cover all modifications, alternative constructions, and equivalents falling within the spirit and scope of the claims.

What is claimed is:

1. An apparatus,
a frame assembly having a plurality of engagement interfaces at different engagement levels for engaging a plurality of panels;
a first engagement level operable to engage a first panel; and
a second engagement level operable to engage a second panel such that the second level is set apart from the first level.

2. The apparatus of claim 1, further comprising a first panel wherein the first panel comprises a glazing suited for exterior exposure.

3. The apparatus of claim 1, further comprising a second panel wherein the second panel comprises a glazing suited for interior exposure.

4. The apparatus of claim 1, further comprising a first and second panel engaged with the frame assembly and each disposed having a flat surface parallel to each other and spaced apart at a distance of approximately four inches forming a cavity between the first and second panels.

5. The apparatus of claim 4, wherein the first panel comprises a barrier between an exterior and the cavity and the second panel comprises a barrier between an interior and the cavity.

6. The apparatus of claim 5, wherein the cavity is operable to provide a thermal barrier between the exterior and the interior.

7. The apparatus of claim 5, further comprising a moisture proof seal at the second panel such that moisture is prevented from moving from the cavity to the interior.

8. The apparatus of claim 5, further comprising a treatment to the second panel, the treatment comprising one from the group including: applied coatings, tinting, polarizing, double-glazing, nanogel fill; gas-fill; etching; composite structuring; and thickness adjustment.

9. The apparatus of claim 5, further comprising a release coupled to the second panel and operable to disengage the second panel from the assembly when actuated.

10. An enhancement window, comprising
a glazing; and
a glazing frame engaged with the glazing and having mounting members suited to interface with an installed window such that the glazing is disposed enclosing a cavity between the window and the glazing.

11. The enhancement window of claim 10 wherein the enhancement panel is operable to form a thermal cavity when engaged with the installed window at a distance of four inches in depth.

12. The enhancement window of claim 10 wherein the glazing comprises a material from the group including: glass, acrylic, polycarbonate, and structured polycarbonate.

13. The enhancement window of claim 10, further comprising a treatment suited for energy efficiency.

14. The enhancement window of claim 10 wherein the glazing frame comprises a material from the group including: aluminum, steel, vinyl, and plastic.

15. A skylight, comprising:
an opening in a surface;
a curb disposed around the opening, the curb comprising a top-side and a bottom-side;
a frame assembly operable to interface with the opening and mountable on the curb, the frame assembly having an engagement device for a first panel and a second panel;
a first panel engaged with the frame assembly at a level of the top-side of the curb; and
a second panel engaged with the frame assembly at a level of the bottom-side of the curb.

16. The skylight of claim 15, further comprising a skylight suited for an opening in a rooftop of a building.

17. The skylight of claim 15 wherein the first panel is suited to comply with loading and weather requirements and the wherein the second panel is suited to comply with energy-efficiency requirements.

18. The skylight of claim 15 wherein the first panel comprises a structured polycarbonate panel operable to withstand impacts from falling debris and the second panel comprises tempered glass operable to provide a thermal barrier.

19. A method, comprising:
retrofitting an installed window having a window panel with an enhancement window such that the enhancement window is secured to the installed window; and
sealing the enhancement window to create a cavity between the enhancement window and the installed window such that a thermal barrier is formed between an interior and the installed window

20. The method of claim 19, further comprising creating a water-tight seal between the interior and the installed window.

21. The method of claim 20, further comprising providing a treatment for the enhancement window to increase energy efficiency.
